(19) United States
(12) Patent Application Publication
(10) Pub. No.: US 2010/0036704 A1
(43) Pub. Date: Feb. 11, 2010

(54) METHOD AND SYSTEM FOR ALLOCATING REQUIREMENTS IN A SERVICE ORIENTED ARCHITECTURE USING SOFTWARE AND HARDWARE STRING REPRESENTATION

(75) Inventor: Joseph J. ROMANO, JR., Potomac Falls, VA (US)

Correspondence Address: GREENBLUM & BERNSTEIN, P.L.C., 1950 ROLAND CLARKE PLACE, RESTON, VA, 20191, US

(73) Assignee: INTERNATIONAL BUSINESS MACHINES CORPORATION, Armonk, NY (US)

(21) Appl. No.: 12/192,768

(22) Filed: Aug. 15, 2008

Related U.S. Application Data
(60) Provisional application No. 61/086,333, filed on Aug. 5, 2008.

(51) Int. Cl. G06Q 10/00

(52) U.S. Cl. 705/8; 705/7

(57) ABSTRACT

A method implemented in a computer infrastructure having computer executable code tangibly embodied on a computer readable medium having programming instructions operable to assign a business process identifier to a business process and allocate requirements to the business process. Additionally, the programming instructions are operable to create one or more service strings used to provide the requirements for the business process, wherein each service string identifies software components used to execute the business process. Furthermore, the programming instructions are operable to create one or more hardware strings for the business process, wherein each hardware string identifies hardware components used to execute the business process.

### CROSS REFERENCE TO RELATED APPLICATION

This application claims priority under 35 U.S.C. 119 to provisional application Ser. No. 61/086,333, filed on Aug. 5, 2008, the contents of which are incorporated by reference in their entirety herein.

### FIELD OF THE INVENTION

The present invention generally relates to service oriented architecture (SOA), and more particularly, to a method for allocating requirements in a service oriented architecture using software and hardware string representation.

### BACKGROUND

Service oriented architecture (SOA) is a software architecture where functionality is grouped around business processes and packaged as interoperable services. SOA also describes IT infrastructure which allows different applications to exchange data with one another as they participate in business processes. An SOA can be defined as a group of services, which communicate with each other. The process of communication may involve, for example, either simple data passing or two or more services coordinating some activity. Additionally, SOA is a design framework for realizing rapid and low-cost system development and improving total system quality. SOA uses the Web services standards and technologies and is rapidly becoming a standard approach for enterprise information systems.

An aim of SOA is a loose coupling of services with operating systems, programming languages and other technologies which underlie applications. SOA separates functions into distinct units, or services, which are made accessible over a network in order that they can be combined and reused in the production of business processes or applications. These services communicate with each other, for example, by passing data from one service to another, or by coordinating an activity between two or more services.

SOAs build applications out of software services. Services are intrinsically unassociated units of functionality, which have no calls to each other embedded in them. The software services typically implement functionalities most humans would recognize as a service, such as filling out an online application for an account, viewing an online bank statement, or placing an online booking or airline ticket order. However, instead of services embedding calls to each other in their source code, with SOA, protocols are defined which describe how one or more services can talk to each other. This architecture then relies on a business process expert to link and sequence services, in a process known as orchestration, to meet a new or existing business system requirement.

Thus, SOA allows fairly large chunks of functionality to be strung together to form ad hoc applications which may be built almost entirely from existing software services. The larger the chunks, the fewer the interface points required to implement any given set of functionality; however, very large chunks of functionality may not be granular enough to be easily reused. Each interface brings with it some amount of processing overhead, so there may be a performance consideration in choosing the granularity of services.

However, there are many problems that are to be addressed when applying the SOA paradigm to a real-time system, which include response time, support of event-driven, asynchronous parallel applications, complicated human interface support, reliability, etc. For example, systems and software best practices require allocation of requirements to the software and hardware that satisfy each requirement. With conventional systems, this may be accomplished using a software tool, for example, Rational® Requisite Pro®. (Rational and Requisite Pro are trademarks of International Business Machines Corporation in the United States, other countries, or both.) However, SOA brings a higher level of complexity of requirements allocation and traceability to software and hardware than earlier architectures. This higher level of complexity is a result of SOA solutions having a greater degree of the physical distribution of processing, looser coupling among elements participating in each transaction, and higher granularity of supporting software and hardware.

However, current approaches do not allocate requirements to all software and hardware involved in each requirement with a grouping to provide requirements allocation and traceability for a system. For example, due to the potentially large numbers of software and hardware elements allocated to an SOA requirement, allocating requirements to all software and hardware involved in each requirement without any grouping or patterns can be inconsistent and become overly complex and difficult to understand and use.

### SUMMARY

In a first aspect of the invention, a method implemented in a computer infrastructure having computer executable code tangibly embodied on a computer readable medium having programming instructions operable to assign a business process identifier to a business process and allocate requirements to the business process. Additionally, the programming instructions are operable to create one or more service strings used to provide the requirements for the business process, wherein each service string identifies software components used to execute the business process. Furthermore, the programming instructions are operable to create one or more hardware strings for the business process, wherein each hardware string identifies hardware components used to execute the business process.

In another aspect of the invention, a system comprises a business process identifier tool operable to assign a business process identifier to a business process and a requirements allocation tool operable to allocate requirements to the business process. Additionally, the system comprises a service string creation tool operable to create one or more service strings identifying software components used to execute the requirements of the business process. Furthermore, the system comprises a hardware couple/hardware string creation tool operable to create one or more hardware strings based on the one or more service strings.

In an additional aspect of the invention, a computer program product comprising a computer usable medium having readable program code embodied in the medium is provided. The computer program product includes at least one component operable to assign a business process identifier to a business process and allocate requirements to the business process. Additionally, the at least one component is operable to create one or more service strings used to provide the requirements for the business process, wherein each service string identifies software components used to execute the business process. Furthermore, the at least one component to create one or more hardware strings for the business process, wherein each hardware string identifies hardware components used to execute the business process.

In a further aspect of the invention, a method comprises providing a computer infrastructure operable to assign a business process identifier to a business process and allocate requirements to the business process. Additionally, the computer infrastructure is operable to create one or more service strings used to provide the requirements for the business process, wherein each service string identifies software components used to execute the business process. Furthermore, the computer infrastructure is operable to create one or more hardware strings for the business process, wherein each hardware string identifies hardware components used to execute the software components of a single service string. Moreover, the computer infrastructure is operable to create one or more hardware couples for each of the one or more hardware strings, wherein each hardware couple identifies hardware components used to execute an individual software component of the software components of the single service string.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 shows an illustrative environment for implementing steps in accordance with the invention;

FIG. 2 shows an exemplary illustration of the relationships between the constituent elements of an SOA string representation architecture in accordance with aspects of the present invention;

FIG. 3 shows an exemplary illustration of a service string in accordance with aspects of the invention;

FIG. 4 shows an exemplary illustration of a hardware string in accordance with aspects of the invention; and

FIG. 5 shows a flow diagram for implementing aspects of the present invention.

### DETAILED DESCRIPTION

The present invention generally relates to service oriented architecture (SOA), and more particularly, to a method for allocating requirements in a service oriented architecture using software and hardware string representation. More specifically, each requirement is allocated to a specific business-process-software identifier, which is in turn allocated to one or more software service solution patterns or paths, each of which is designated as a “service string”. The software service solution patterns (“software strings”) group, for example, service interfaces, service components, and operating systems. Additionally, each requirement of a business process is allocated to the supporting hardware components on which the software executes, designated as “hardware strings,” which comprise “hardware couples”.

By implementing the present invention, a tight coupling of requirements to the business process identifiers may be established, which will not change, even if, for example, the details of the implementation and supporting software may be expected to change. Additionally, the present invention simplifies allocation and traceability of business processes to groupings of software and hardware used to execute the processes. Furthermore, implementing the present invention extends SOA representations to include hardware necessary for the execution of the SOA software. This facilitates system flexibility and responsiveness to change, which is a benefit attributed to SOA.

Additionally, by implementing the present invention, the impact of changing a business process may be easily traced to the entire set of software and hardware that are impacted. Conversely, the impact of changes to any part of a software string or hardware string to coupled components and all associated business processes may also be easily detected.

### System Environment

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following:
an electrical connection having one or more wires,
a portable computer diskette,
a hard disk,
a random access memory (RAM),
a read-only memory (ROM),
an erasable programmable read-only memory (EPROM or Flash memory),
an optical fiber,
a portable compact disc read-only memory (CDROM),
an optical storage device,
a transmission media such as those supporting the Internet or an intranet, or a magnetic storage device.

The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network. This may include, for example, a local area network (LAN) or a wide area network (WAN), or the connection may be made to an external computer (for example, through the Internet using an Internet Service Provider).

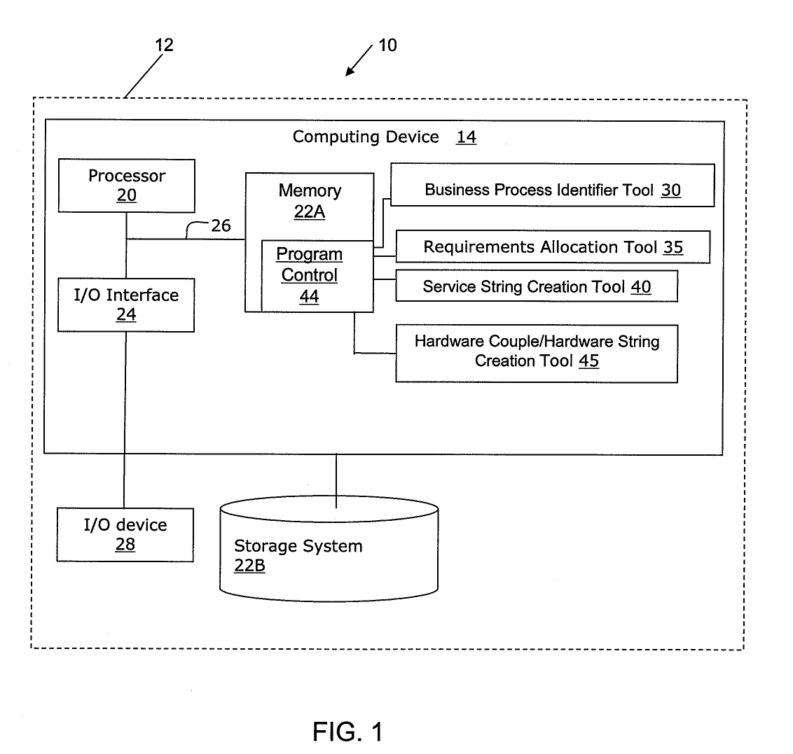

FIG. 1 shows an illustrative environment 10 for managing the processes in accordance with the invention. To this extent, the environment 10 includes a server or other computing system 12 that can perform the processes described herein. In particular, the server 12 includes a computing device 14. The computing device 14 can be resident on a network infrastructure or computing device of a third party service provider (any of which is generally represented in FIG. 1).

The computing device 14 includes a business process identification tool 30, a requirements allocation tool 35, a service string creation tool 40 and a hardware couple/hardware string creation tool 45. These tools are operable to assign a business process identifier to a business process, allocate the requirements of the business process, create a service string and create a hardware string and hardware couples, e.g., the processes described herein. The business process identification tool 30, the requirements allocation tool 35, the service string creation tool 40 and the hardware couple/hardware string creation tool 45 can be implemented as one or more program code stored in memory 22A as separate or combined modules.

The computing device 14 also includes a processor 20, memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and a CPU.

The computing device 14 is in communication with the external I/O device/resource 28 and the storage system 22B. For example, the I/O device 28 can comprise any device that enables an individual to interact with the computing device 14 or any device that enables the computing device 14 to communicate with one or more other computing devices using any type of communications link. The external I/O device/resource 28 may be for example, a handheld device, PDA, handset, keyboard etc.

In general, the processor 20 executes computer program code, which can be stored in the memory 22A and/or storage system 22B. While executing the computer program code, the processor 20 can read and/or write data to/from memory 22A, storage system 22B, and/or I/O interface 24. The program code executes the processes of the invention. The bus 26 provides a communications link between each of the components in the computing device 14.

The computing device 14 can comprise any general purpose computing article of manufacture capable of executing computer program code installed thereon (e.g., a personal computer, server, etc.). However, it is understood that the computing device 14 is only representative of various possible equivalent-computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computing infrastructure 12 is only illustrative of various types of computer infrastructures for implementing the invention. For example, in embodiments, the server 12 comprises two or more computing devices (e.g., a server cluster) that communicate over any type of communications link, such as a network, a shared memory, or the like, to perform the process described herein. Further, while performing the processes described herein, one or more computing devices on the server 12 can communicate with one or more other computing devices external to the server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

In embodiments, the invention provides a business method that performs the steps of the invention on a subscription, advertising, and/or fee basis. That is, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

### Business Process Requirements Allocation

According to aspects of the invention, in embodiments, functional and technical requirements may be grouped and allocated to particular business processes. More specifically, the business process identification tool 30 may assign each business process a specific business process identifier. Additionally, the business requirements allocation tool 35 may allocate one or more requirements to each business process. As such, the relationship between the business process and the one or more requirements is a one-to-many relationship. Furthermore, the business process identifiers and their corresponding requirement allocations may be stored in a data storage, for example, storage system 22B shown in FIG. 1, e.g., a database.

Each business process is typically implemented in software, for example, Business Process Execution Language (BPEL). BPEL is a language for specifying business process behavior based on Web Services. Processes in Web Service (WS)-BPEL export and import functionality by using Web Service interfaces. Business processes may be described in two ways: (1) executable business process; and (2) abstract business process. Executable business processes model actual behavior of a participant in a business interaction. Abstract business processes are partially specified processes that are not intended to be executed. Moreover, an abstract business process may hide some of the required concrete operational details. Additionally, abstract business processes serve a descriptive role, with more than one possible use case, including, for example, observable behavior and process template.

WS-BPEL is used to model the behavior of both executable and abstract processes. That is, WS-BPEL provides a language for the specification of executable and abstract business processes. By doing so, WS-BPEL extends the Web Services interaction model and enables it to support business transactions. Moreover, WS-BPEL defines an interoperable integration model that facilitates the expansion of automated process integration in both the intra-corporate and the business-to-business spaces.

As further explanation, BPEL is an orchestration language and not a choreography language. The primary difference between orchestration and choreography is executability and control. An orchestration language specifies an executable process that involves message exchanges with other systems, such that the message exchange sequences are controlled by the orchestration designer. In contrast, a choreography language specifies a protocol for peer-to-peer interactions, defining, e.g., the legal sequences of messages exchanged with a purpose of guaranteeing interoperability. However, such a protocol is not directly executable, as it allows many different realizations (e.g., processes that comply with it). A choreography can be realized by writing an orchestration (e.g., in the form of a BPEL process) for each peer involved in it. To put it another way, the orchestration and the choreography distinctions are based on analogies: orchestration refers to the central control (by the conductor) of the behavior of a distributed system (the orchestra consisting of many players). Choreography, on the other hand, refers to a distributed system (the dancing team) without centralized control.

Thus, the business requirements allocation tool 35 may parse a business process into the discrete requirements for the business process. As described above, in embodiments, this determination of the requirements of the business process may be accomplished using, for example, Rational Requisite Pro. That is, in embodiments, the business requirements allocation tool 35 utilizes a software tool, such as Rational Requisite Pro. Furthermore, as described further below, this determination of the requirements of a business process may be performed manually, for example, by an orchestrator, who may then input the requirements of the business process into the system of the present invention via the business requirements allocation tool 35.

Each of these requirements of the business process may be provided by a particular executable business process. In embodiments, executable business processes may be stored in a storage device, e.g., storage system 22B (shown in FIG. 1). Moreover, a particular executable business process may utilize one or more sets of services, service components (e.g., SOA service components), and operating systems. Furthermore, the stored executable business processes may indicate the sets of services, service components (e.g., SOA service components), and operating systems utilized by the business processes.

Additionally, a particular executable business process may utilize one or more hardware devices. Moreover, in embodiments, the sets of services, service components (e.g., SOA service components), and operating systems may indicate the one or more hardware devices utilized by the sets of services, service components, and operating systems.

### Service String Creation

In accordance with aspects of the invention, the service string creation tool 40 allocates each business process to one or more sets of services, service components, and operating systems. That is, the service string creation tool 40 allocates each business process to software components (e.g., legacy system, commercial off the shelf (COTS) product, and/or developed code) used to execute the business process to satisfy the requirements of the business process. Moreover, the service string creation tool 40 designates each allocation or path of a business process to the software components used to execute that business process as a “service string”. The relationship of business processes to service strings is one-to-many. That is, a single business process may comprise many service strings.

In embodiments, the service string creation tool 40 allocates the software components of the business process by identifying those sets of services, service components (e.g., SOA service components), and operating systems, for example, identified by an executable business process, e.g., stored in a storage device, for example, storage system 22B.

Moreover, in accordance with aspects of the invention, service strings need not be unique to each business process. That is, for example, an individual service string may be utilized for a number of different business processes. As described above, the service strings may be stored in a storage system, e.g., storage system 22B. In embodiments, the service string creation tool 40 may access the storage system, e.g., storage system 22B, and reuse a particular service string, for example, with a same business process or a different business process sharing, for example, a common service string.

For example, a business process may have a plurality of business requirements and may involve a plurality of service strings used to execute the requirements of the business process. Additionally, for example, a different but similar business process may be able to utilize one of the service strings used in the first business process. Thus, the service string creation tool 40 may reuse service amongst different business processes. Moreover, this reuse of service strings simplifies the relationship between a business process and its service strings.

In accordance with further aspects of the invention, the service string creation tool 40 is operable to identify common usages of the same or similar service strings used, for example, amongst different business processes. Moreover, the service string creation tool 40 is operable to store these identified common usages of the service strings in a data storage, e.g., storage system 22B. By identifying common usages of the same or similar service strings, the service string creation tool 40 is able to more efficiently reuse service strings.

### Hardware String and Hardware Couple Creation

According to further aspects of the invention, the hardware couple/hardware string creation tool 45 couples each identifiable software item, e.g., SOA component, in a service string with the hardware, or hardware grouping, on which that software item executes to create a “hardware couple”. Further, these hardware couples may be stored in a database, e.g., storage system 22B.

Moreover, the hardware couple/hardware string creation tool 45 designates the total set of “hardware couples” comprising a hardware couple for each software item of a particular “service string” as a “hardware string”. Thus, the relationship between a hardware string and its hardware couples may be a one-to-many. However, the invention contemplates that in embodiments, a hardware string may include only a single hardware couple, in which case, the relationship would be one-to-one. Furthermore, the relationship between “service strings” and “hardware strings” is one-to-one. That is, each service string is directly correlated with a corresponding hardware string. Additionally, the hardware couple/hardware string creation tool 45 is operable to store the relationships between the service strings and the hardware strings, as well as the relationships between the hardware strings and their respective hardware couples in a storage device, e.g., storage system 22B.

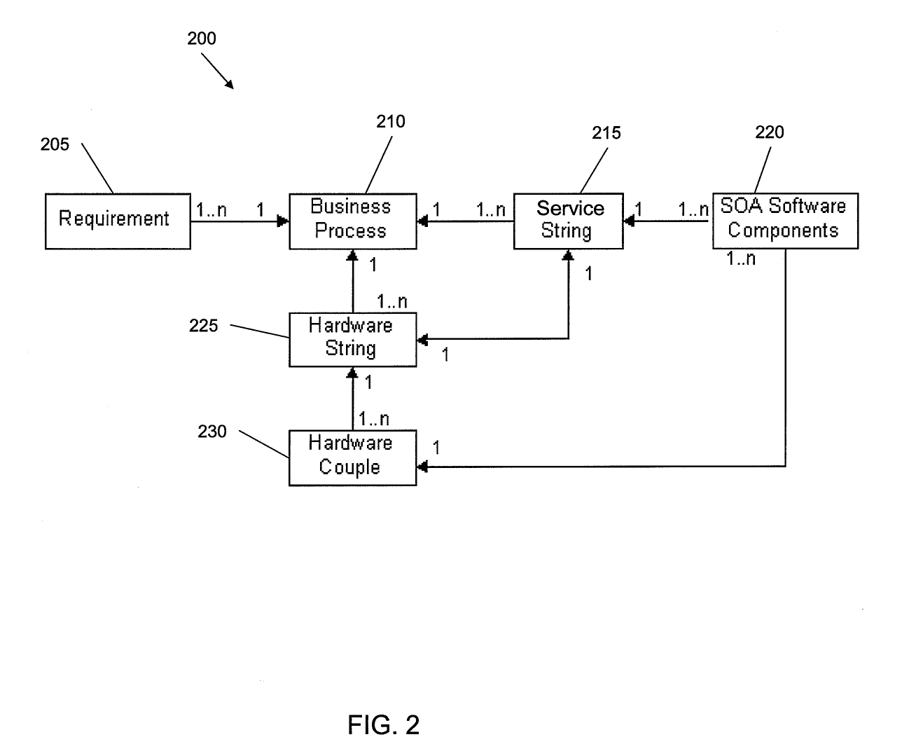

FIG. 2 shows an exemplary illustration of the relationships between the above-described constituent elements of an SOA string representation architecture in accordance with the present invention. As shown in FIG. 2, a business process 210 may have one or more requirements 205. Additionally, the business process 210 may comprise one or more software service strings 215 used to accomplish the one or more business requirements of the business process. Moreover, each service string 215 comprises one or more SOA software components 220 used to perform the business process. Each service string 215 is related to a corresponding hardware string 225, which identifies the hardware elements used to execute the software elements of the service string 215. Furthermore, each hardware string 225 comprises one or more hardware couples 230. Moreover, each hardware couple 230 may be related to one or more SOA software components 220 that execute on the hardware elements of a particular hardware couple 230.

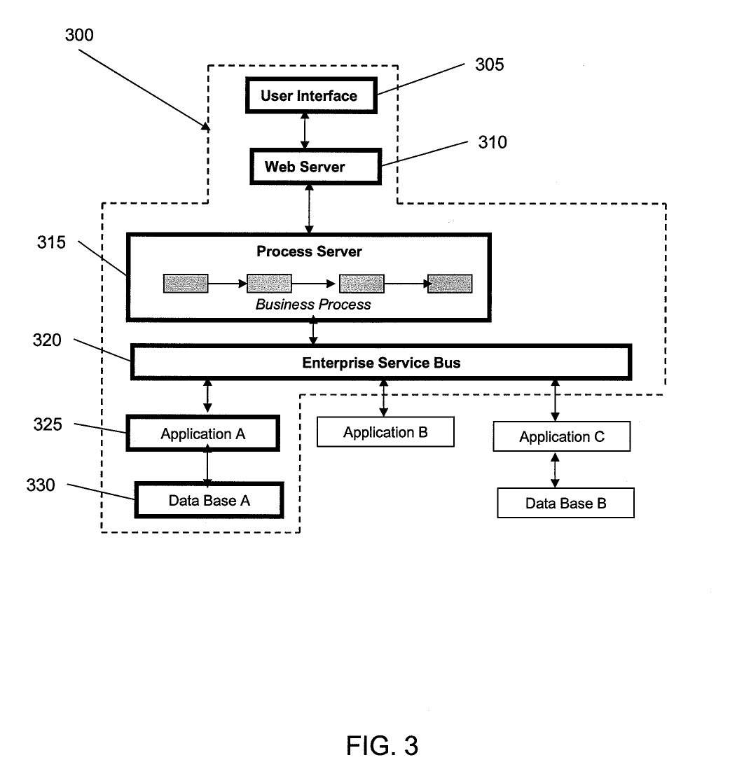

FIG. 3 shows an exemplary service string 300 (e.g., service string A) in accordance with aspects of the invention. Moreover, as should be understood, service string 300 may be a portion of a business process. That is, a business process may comprise, for example, service string A, service string B and service string C.

As shown in FIG. 3, the exemplary service string 300 comprises a user interface 305, a web server 310, a process server 315, enterprise service bus 320, an application A 325 and a database A 330. Moreover, in accordance with aspects of the invention, each element of the service string 300 may be a loosely-coupled software component or product (e.g., SOA component).

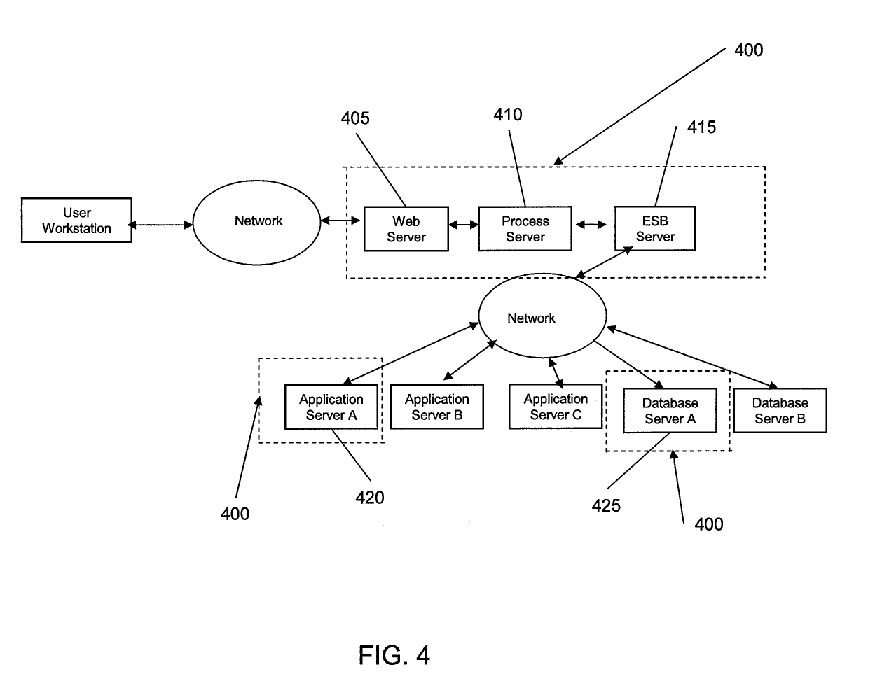

FIG. 4 shows an exemplary hardware string 400 in accordance with aspects of the invention. Moreover, the exemplary hardware string 400 corresponds with the service string 300 shown in FIG. 3 in accordance with aspects of the invention. That is, software string 300 runs on hardware string 400. As shown in FIG. 4, the hardware string comprises a web server 405, a process server 410, an enterprise serial bus (ESB) server 415, an application server A 420 and a database server A 425. Additionally, as should be understood, a business process may comprise, more than one hardware string, for example, hardware string A, hardware string B and hardware string C. Moreover, as discussed above, with the above example, hardware string B corresponds with service string B and hardware string C corresponds to service string C. Moreover, as should be understood, different hardware strings, e.g., hardware string A and hardware string B may share common elements amongst each other. That is, with the above example, hardware string A and hardware string B each includes a web server 405, a process server 410, an enterprise serial bus (ESB) server 415.

### Flow Diagram

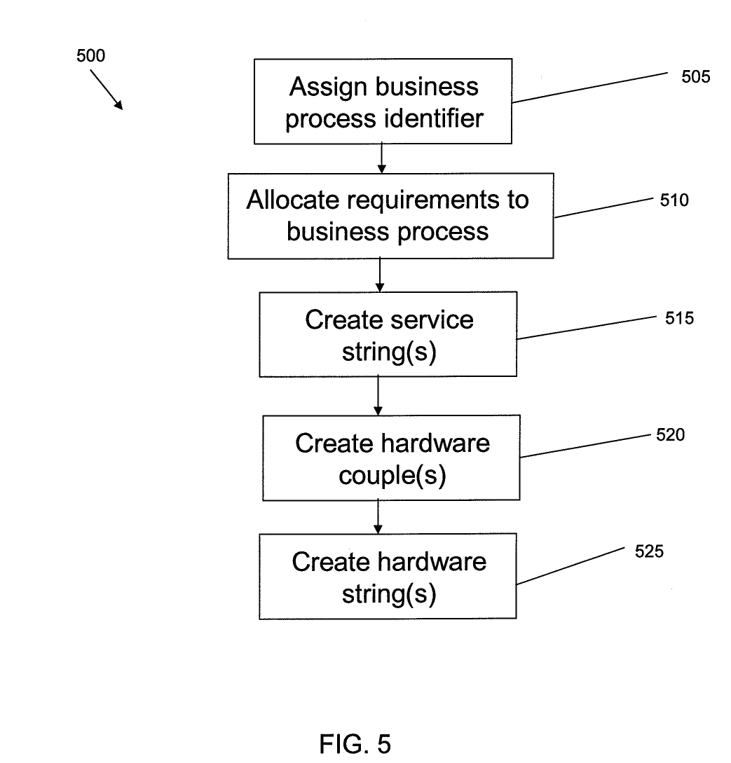

FIG. 5 shows an exemplary flow for performing steps of the invention. The steps of FIG. 5 may be implemented in the environment of FIG. 1, for example. The flow diagram may equally represent a high-level block diagram of the invention. The flowchart and/or block diagram in FIG. 3 illustrates the architecture, functionality, and operation of possible implementations of systems, methods and computer program products according to various embodiments of the present invention. In this regard, each block in the flowchart or block diagram may represent a module, segment, or portion of code, which comprises one or more executable instructions for implementing the specified logical function(s). It should also be noted that, in some alternative implementations, the functions noted in the block may occur out of the order noted in the figure. For example, two blocks shown in succession may, in fact, be executed substantially concurrently, or the blocks may sometimes be executed in the reverse order, depending upon the functionality involved. Each block of the flowchart, and combinations of the flowchart illustrations can be implemented by special purpose hardware-based systems that perform the specified functions or acts, or combinations of special purpose hardware and computer instructions and/or software, as described above. Moreover, the steps of the flow diagram may be implemented and executed from either a server, in a client server relationship, or they may run on a user workstation with operative information conveyed to the user workstation. In an embodiment, the software elements include firmware, resident software, microcode, etc.

Furthermore, the invention can take the form of a computer program product accessible from a computer-usable or computer-readable medium providing program code for use by or in connection with a computer or any instruction execution system. The software and/or computer program product can be implemented in the environment of FIG. 1. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

FIG. 5 shows an exemplary flow 500 for assigning service strings, hardware strings and hardware couples to a business process in accordance with aspects of the invention. As shown in FIG. 5, at step 505 the business process identifier tool assigns a business process identifier to a business process. At step 510, the requirements allocation tool allocates requirements to the business process. As described above, the requirements allocation tool may utilize a software tool, such as, for example, Rational Requisite Pro, and/or may utilize operator intervention to allocate the requirements to a business process. At step 515, the service string creation tool creates one or more service strings based on the allocation of the business requirements. For example, the service string creation tool may utilize a previously identified relationship between, e.g., a stored executable business process and its sets of services, service components (e.g., SOA service components), and operating systems. At step 520, the hardware couple/hardware string creation tool creates one or more hardware couples based on the service string(s). At step 525, the hardware couple/hardware string creation tool creates one or more hardware strings comprising one or more of the hardware couples.

Moreover, while the invention has been described using the business process identification tool 30, the requirements allocation tool 35, the service string creation tool 40, and the hardware couple/hardware string creation tool 40, the invention contemplates that any of the operations performed by the business process identification tool 30, the requirements allocation tool 35, the service string creation tool 40, and the hardware couple/hardware string creation tool 40 may be combined into one as a combination of different tools depending on programming logic, or may be performed manually by a user (e.g., a data center employee). For example, in embodiments, a employee may manually assign a business process identifier to a business process.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

What is claimed is:

1. A method implemented in a computer infrastructure comprising computer executable code tangibly embodied on a computer readable medium having programming instructions operable to:
assign a business process identifier to a business process;
allocate requirements to the business process;
create one or more service strings used to provide the requirements for the business process, wherein each service string identifies software components used to execute the business process; and
create one or more hardware strings for the business process, wherein each hardware string identifies hardware components used to execute the business process.

2. The method of claim 1, wherein the software components comprise service oriented architecture (SOA) software components.

3. The method of claim 1, wherein the one or more hardware strings each comprise one or more hardware couples.

4. The method of claim 1, wherein a corresponding hardware string is created for each software string.

5. The method of claim 1, further comprising storing the business process identifier with at least one of the allocated requirements to the business process, the created one or more service strings for the business process and the created one or more hardware strings for the business process.

6. The method of claim 1, wherein the business process comprises a service oriented architecture (SOA).

7. The method of claim 1, wherein the one or more service strings and the one or more hardware strings provide allocation and traceability of the business process to groupings of software and hardware used to execute the business process.

8. The method of claim 1, wherein the one or more hardware strings extend SOA representations to include hardware necessary for an execution of SOA software.

9. The method of claim 1, further comprising utilizing the one or more service strings and one or more hardware strings to trace an impact of changing a business process to an entire set of software and hardware impacted by the changing of the business process.

10. The method of claim 1, further comprising utilizing the one or more service strings and one or more hardware strings to at least one of detect and assess an impact of changes to any part of the service string or the hardware string to coupled components and the business process.

11. The method of claim 1, further comprising identifying a common service string usable with different business processes.

12. The method of claim 1, further comprising identifying at least one of a common hardware string a common hardware couple usable with different business processes.

13. The method of claim 1, wherein a service provider at least one of creates, maintains, deploys and supports the computer infrastructure that performs the steps of claim 1.

14. The method of claim 1, wherein steps of claim 1 are provided by a service provider on a subscription, advertising, and/or fee basis.

15. A system, comprising:
a business process identifier tool operable to assign a business process identifier to a business process;
a requirements allocation tool operable to allocate requirements to the business process;
a service string creation tool operable to create one or more service strings identifying software components used to execute the requirements allocated to the business process; and
a hardware couple/hardware string creation tool operable to create one or more hardware strings based on the one or more service strings.

16. The system of claim 15, wherein the hardware couple/hardware string creation tool is further operable to create one or more hardware couples based on the one or more service strings.

17. The system of claim 15, wherein the software components comprise service oriented architecture (SOA) software components.

18. The system of claim 15, wherein a corresponding hardware string is created for each software string.

19. The system of claim 15, further comprising a storage system operable to store the business process identifier with at least one of the allocated requirements of the business process, the one or more software strings for the business process and the one or more hardware strings for the business process.

20. The system of claim 15, comprising a computer infrastructure operable to implement the business process identifier tool, the requirements allocation tool, the service string creation tool and the hardware couple/hardware string creation tool, wherein a service provider at least one of creates, maintains, deploys and supports the computer infrastructure.

21. The system of claim 15, wherein the system is operable on software, hardware or a combination of software and hardware.

22. A computer program product comprising a computer usable medium having readable program code embodied in the medium, the computer program product includes at least one component operable to:
assign a business process identifier to a business process;
allocate requirements to the business process;
create one or more service strings used to provide the requirements for the business process, wherein each service string identifies software components used to execute the business process; and
create one or more hardware strings for the business process, wherein each hardware string identifies hardware components used to execute the business process.

23. A method comprising:
providing a computer infrastructure operable to:
assign a business process identifier to a business process;
allocate requirements to the business process;
create one or more service strings used to provide the requirements for the business process, wherein each service string identifies software components used to execute the business process;
create one or more hardware strings for the business process, wherein each hardware string identifies hardware components used to execute the software components of a single service string; and
create one or more hardware couples for each of the one or more hardware strings, wherein each hardware couple identifies hardware components used to execute an individual software component of the software components of the single service string.
